(19) United States
(12) Patent Application Publication
(10) Pub. No.: US 2025/0137641 A1
(43) Pub. Date: May 1, 2025

(54) IGNITION SYSTEMS FOR EXOTHERMIC WELDING

(71) Applicant: ERICO International Corporation, Solon, OH (US)

(72) Inventors: Greg Martinjak, Solon, OH (US); Nicholas J. Turner, North Royalton, OH (US)

(21) Appl. No.: 18/929,075

(22) Filed: Oct. 28, 2024

Related U.S. Application Data
(60) Provisional application No. 63/593,500, filed on Oct. 26, 2023.

(51) Int. Cl. F23Q 3/00; B23K 20/16

(52) U.S. Cl. CPC F23Q 3/004; B23K 20/165

(57) ABSTRACT

The disclosed technology provides improved systems and methods for exothermic welding. An ignition strip can include a printed circuit board (PCB). The PCB can include a first contact, a second contact, and a dielectric layer with an aperture. A first conductive layer can define a first trace between the first contact and the aperture along a first side of the dielectric layer. A second conductive layer can define a second trace between the second contact and the aperture along a second side of the dielectric layer. The aperture can define an insulating gap between the first trace and the second trace to cause a spark for ignition of welding material upon application of a breakdown voltage across the first and second contacts.

### CROSS-REFERENCE TO RELATED APPLICATIONS

This application claims priority to and incorporates by reference U.S. provisional patent application No. 63/593,500, filed Oct. 26, 2023.

### BACKGROUND

Exothermic welding can be used in different settings to form high quality, high ampacity, and low resistance electrical connections between different conductors (e.g., grounding electrode conductors or bonding conductors) and conductors to a grounding electrode or a point on a grounding electrode system. In general, an exothermic welding process can provide a bond with a current carrying capacity substantially greater than or equal to that of the conductors themselves. Further, exothermic welds can be relatively durable and long-lasting, and can avoid problems of loosening and corrosion that can occur for mechanical and compression joints. As a result of these benefits, exothermic weld connections are widely used in electrical grounding and bonding systems and other settings to enable connected sets of conductors, or connections between a conductor and another point on the grounding electrode system, to operate, effectively, as a continuous conductor with relatively low resistivity.

### SUMMARY

The present disclosure relates to exothermic welding and, in particular, to improved assemblies and methods for ignition of welding material.

In some aspects, the present disclosure can provide an ignition strip for exothermic welding. The ignition strip can include a printed circuit board (PCB) that includes a first contact, a second contact, and a dielectric layer with an aperture. A first conductive layer can define a first trace between the first contact and the aperture along a first side of the dielectric layer. A second conductive layer can define a second trace between the second contact and the aperture along a second side of the dielectric layer. The aperture can define an insulating gap between the first and second traces and can cause a spark for ignition of welding material upon application of a breakdown voltage across the first and second contacts.

In some examples, the PCB can bend to extend along at least two reference planes.

In some examples, the first conductive layer can be metallic.

In some examples, the first conductive layer can include aluminum.

In some examples, the second conductive layer can include copper.

In some examples, the breakdown voltage can be approximately 120V or less.

In some examples, the PCB can further include an outer edge. The PCB can provide the spark as a result of a current traveling along the outer edge, between the first trace and the second trace.

In some aspects, the present disclosure can provide an exothermic welding device including a weld container defining an internal volume that can include a main charge of welding material. A cover can close the internal volume to retain the main charge of welding material. An igniter can include a printed circuit board (PCB) that can define an insulating gap between a first trace and a second trace. The insulating gap can provide a spark for ignition of the main charge of welding material upon application of a threshold voltage across the insulating gap. The igniter can have a first end that protrudes to the outside of the weld container for application of the breakdown voltage.

In some examples, the igniter can be in contact with the main charge of welding material or an ignition charge of welding material at the insulating gap.

In some examples, the igniter can include a bend within the internal volume to orient the insulating gap within the main charge of the welding material.

In some examples, the igniter is in contact with the ignition charge and the ignition charge does not include starting material.

In some examples, the device can include a capacitor. The capacitor can apply a charge to the igniter to cause application of the breakdown voltage across the insulating gap.

In some examples, the insulating gap is arranged to cause discharge over an outer edge of the PCB upon application of the breakdown voltage.

In some aspects, the present disclosure provides a method of welding conductive components together. An igniter can be provided that can include a printed circuit board (PCB) that can define a dielectric layer and an air gap between a first trace and a second trace. A weld container can be aligned for a welding operation. A first end of the igniter can be extended into the weld container. The weld container can include a main charge of welding material. A breakdown voltage can be applied across the air gap via the first trace and second traces to provide a spark that can ignite a charge of welding material.

In some examples, the breakdown voltage can be approximately 120V or less.

In some examples, the igniter can extend within a sealed weld container that can include the charge of welding material.

In some examples, the igniter can include a first contact, and a second contact. A first conductive layer can be in electrical communication with the first contact. A second conductive layer can be in electrical communication with the second contact and can be separated from the first conductive layer by the air gap.

In some examples, a capacitive discharge can be applied to the first contact. The capacitive discharge can cause current to pass from the first trace to the second trace across the air gap via an outer edge of the PCB.

In some examples, the igniter can be bent to extend along at least two reference planes. The breakdown voltage can be applied across the first and second contact with the PCB extending along a different reference plane at the first and second contacts than at the air gap.

### BRIEF DESCRIPTION OF THE DRAWINGS

The accompanying drawings, which are incorporated in and form a part of this specification, illustrate embodiments of the invention and, together with the description, serve to explain the principles of embodiments of the invention.

FIG. 1 shows an exothermic welding system according to the present disclosure, including an igniter according to the present disclosure.

FIG. 2A is a schematic first view of a board layout of an ignition strip, according to the present disclosure, as an example of the igniter of FIG. 1.

FIG. 2B is a schematic second view of a board layout of the ignition strip of FIG. 2A.

FIG. 3 is an exploded view of layers of a two-layer PCB for igniters according to the present disclosure.

FIG. 4A is a side sectional view of an example exothermic welding system including an exothermic welding container and an igniter according to the present disclosure.

FIG. 4B is a side sectional view of an alternate configuration of the exothermic welding system of FIG. 4B, including an ignition charge of welding material, according to the present disclosure.

FIG. 5A is a schematic first view of a board layout of an ignition strip according to the present disclosure.

FIG. 5B is a schematic second view of a board layout of the ignition strip of FIG. 5A.

FIG. 5C is schematic detail view of a contact of the ignition strip of FIG. 5A.

### DETAILED DESCRIPTION

Before any examples of the disclosed technology are explained in detail, it is to be understood that the disclosed technology is not limited in its application to the details of construction and the arrangement of components set forth in the following description or illustrated in the following drawings. The disclosed technology is capable of other implementations and of being practiced or of being carried out in various ways. Also, it is to be understood that the phraseology and terminology used herein is for the purpose of description and should not be regarded as limiting.

The following discussion is presented to enable a person skilled in the art to make and use examples of the disclosed technology. Various modifications to the illustrated examples will be readily apparent to those skilled in the art, and the generic principles herein can be applied to other examples and applications without departing from the disclosed technology. Thus, the disclosed technology are not intended to be limited to examples shown, but are to be accorded the widest scope consistent with the principles and features disclosed herein. The following detailed description is to be read with reference to the figures, in which like elements in different figures have like reference numerals. The figures, which are not necessarily to scale, depict selected examples and are not intended to limit the scope of examples of the disclosed technology. Skilled artisans will recognize the examples provided herein have many useful alternatives that also fall within the scope of the disclosed technology.

As noted above, exothermic welding can be used to connect together metal structures, including copper conductors of an electrical system. Generally, exothermic mixtures can include a combination of a reductant metal and a transition metal oxide, which upon ignition react exothermically to supply sufficient heat to propagate and sustain a continuing reaction of the mixture. The resulting heat can be used directly, or the resulting molten metal can be used to create a useful weld, as in the case of exothermic welding.

Exothermic mixtures of this type do not react spontaneously and need a method of initiating the reaction, which involves generating enough localized energy to enable the exothermic reaction to begin. One typical method of initiating ignition is through the use of starting powder and an ignition source such as a flint igniter. However, the use of starting powder requires a user to correctly place the starting powder to ensure proper ignition of the exothermic mixture, which can be difficult in some settings. Starting power can also be difficult and costly to handle and transport.

Conventional approaches to providing ignition energy are also in need of improvement. For example, conventional electrical ignition strips (e.g., with gap-bridging wires for heat generation) can be difficult to manufacture with reliable quality and may require a large number of relatively expensive (e.g., non-automated) manufacturing operations. Similarly, mechanical ignition systems may be cumbersome to implement or require substantial space relative to a welding system overall (e.g., and thus reduce portability or overall ease of use).

Examples of the disclosed technology may provide improved ignition systems and methods for exothermic welding that can address various issues noted above and others. For example, some configurations can address issues associated with properly placing starting powder by providing an ignition strip or other igniter which relies on a breakdown voltage to provide an ignition spark instead of starting powder. In particular, some implementations can use a printed circuit board (PCB) configured to generate a spark upon application of a particular voltage (or current)—e.g., via a flashover or a sparkover electrical breakdown. Moreover, some implementations can include igniters with improved flexibility or overall geometry (e.g., formed as a bent or bendable PCB that can be easily adapted to various geometries). Thus, some examples can improve the ability of users to reliably and easily ignite exothermic mixtures, to implement welding operations in a variety of contexts. For example, for portable welding systems, an ignition strip can be readily placed and excited for ignition without needing to correctly place a charge of starting powder or manage other cumbersome components. Moreover, in some examples, the improved flexibility may reduce the costs of manufacturing, as well as allow easy (e.g., widely customized) configurations of igniters for use across various configurations of welding operations. As another example, some igniters disclosed herein can be particularly suitable for use with single-use welding capsules (e.g., sealed cups or other containers that are pre-filled with welding material and include a pre-configured ignition strip).

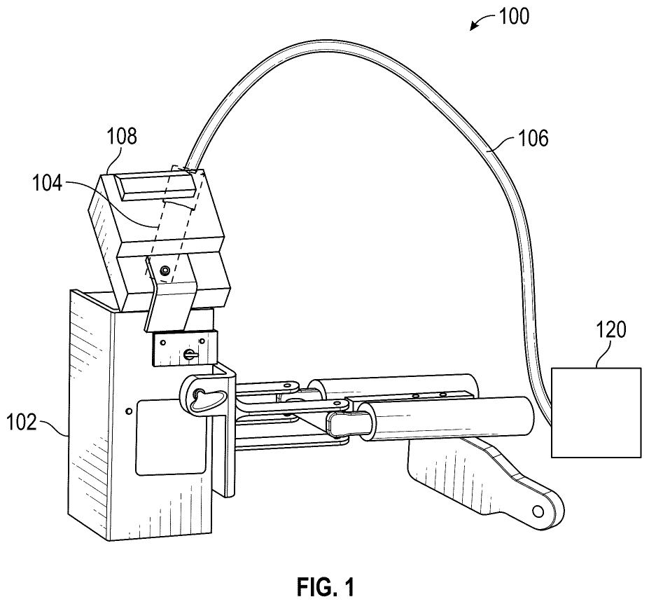

During an exothermic welding process, an exothermic welding system may be used. For example, FIG. 1 illustrate an exothermic welding system 100 which includes an exothermic welding mold 102, an igniter (e.g., an ignition strip 104, shown schematically behind a lid 108 of the exothermic welding mold 102 in FIG. 1), and an impulse cable 106. In the illustrated example, the impulse cable 106 is connected to one end of the ignition strip 104 (or other igniter). The impulse cable 106 thus allows for a voltage to be sent to the ignition strip 104 to initiate the exothermic welding process. In some examples, the voltage sent to the ignition strip 104 may be provided by discharge of a capacitor (e.g., in an ignition control system 120), which may initiate the exothermic welding process.

In the example shown in FIG. 1, an end of the ignition strip 104 not connected to the impulse cable 106 extends within the exothermic welding mold 102. The ignition strip 104 can thus ignite welding material within the exothermic welding mold 102, and the exothermic welding mold 102 may guide the resulting molten metal to weld together metal components (e.g., copper conductors, not shown) in a desired configuration. In different examples, the ignition strip 104 can exhibit various configurations within the exothermic welding mold 102 (e.g., bent configuration), as further discussed below.

Although the arrangement in FIG. 1 may offer particular benefits, other configurations for an exothermic welding system are possible. For example, differently shaped or sized molds can be used (e.g., known mold configurations for various numbers or orientations of conductors or other objects). Further, other systems to transmit electrical power can be used in some examples.

In some embodiments, the exothermic welding system begins the exothermic welding process upon sending a breakdown voltage of approximately 120V or more to the ignition strip 104. In one example, the breakdown voltage is created when a capacitor (not shown) is discharged.

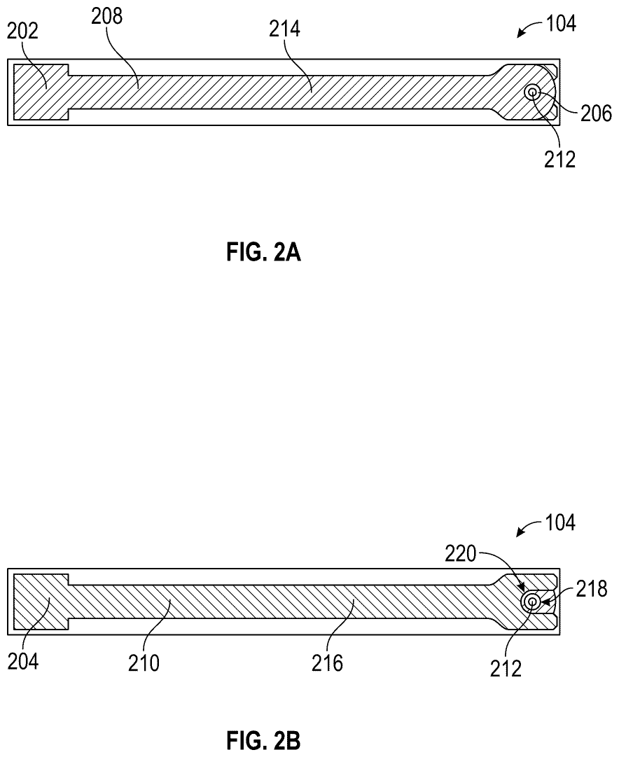

FIGS. 2A and 2B schematically illustrate example board layouts of the ignition strip 104 for exothermic welding processes. In particular, the ignition strip 104 may include a printed circuit board (PCB)—e.g., be formed from a PCB. In some examples, the PCB is manufactured using materials, including aluminum, FR-4, polypropylene, or copper, according to generally known processes. Various other materials can be used, however, according to known practices for PCB manufacturing.

To provide improved adaptability to different operational contexts, the ignition strip 104 and other igniters disclosed herein may include material that allows the ignition strip 104 to be bent plastically after manufacture, or may be manufactured with a bent substrate. In this regard, although the example configuration of FIGS. 2A and 2B is shown as a planar body, some igniters as disclosed herein can include different segments that extend along different reference planes. In some examples, the substrate of an ignition strip may be planar between or extending from one or more radiused bends. In some examples, the substrate may be generally curved, to extend (locally) along different reference planes that are tangent to different points along the substrate. In some examples, a PCB can be similarly included in igniters that are not necessarily strips in form (e.g., an ignition disc, an ignition block, an ignition enclosure, etc.)

The example board layouts of the ignition strip 104 shown in FIGS. 2A and 2B include a PCB with a first contact 202, a second contact 204, a dielectric layer 206, a first conductive layer 208, a second conductive layer 210, and an aperture 212. The dielectric layer 206 may be made from materials including polypropylene or FR-4 (as also discussed above), and the first conductive layer 208 and the first contact 202 may be made of copper or other metallic material.

As shown in FIG. 2A in particular, the first conductive layer 208 defines a first trace 214 between the first contact 202 and the aperture 212. The first contact 202 allows for connections to be made with an impulse cable, which can send voltage or current along the first trace 214 to initiate the exothermic welding process (as further discussed below).

The second conductive layer 210 and the second contact 204 may also be made of a metallic material. As illustrated in FIG. 2B, for example, the second conductive layer 210 defines a second trace 216 between the second contact 204 and the aperture 212. The second trace 216 defines a space between the aperture 212 and the second conductive layer 210.

In other words, in the example shown, the aperture 212 and the second trace 216 can define an insulating gap between the first and second traces 214, 216. Accordingly, when a sufficient voltage difference or electrical current is provided, a spark can be formed in the insulating gap of the aperture 212 to initiate an exothermic welding process.

In the illustrated example, the insulating gap is defined by an insulating surface that extends between and separates edges of the first and second traces 214, 216. The insulating surface is sufficiently less conductive than the traces 214, 216, so current does not flow across the insulating surface at lower voltage differences between the traces 214, 216. However, upon application of sufficient voltage difference between the traces 214, 216 (e.g., with a predefined minimum magnitude), current may flow across the surface between the traces 214, 216 in a flashover electrical breakdown. In some examples, an air gap can be correspondingly provided between electrical traces (e.g., as shown at gap 220 in FIG. 2B), so that a sparkover electrical breakdown occurs upon application of a sufficiently large voltage difference.

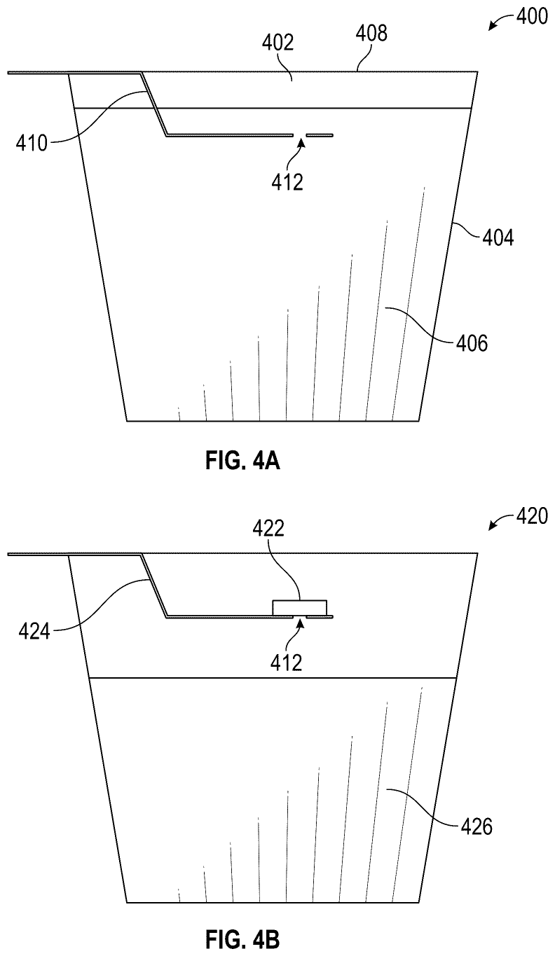

Thus, for example, application of breakdown voltage can cause current to travel along an outer edge (e.g., an exposed conductor 218) of the ignition strip 104, causing the dielectric layer 206 to breakdown. Once the dielectric layer 206 experiences breakdown, the breakdown voltage may flow directly between the traces 214 and 216. As previously mentioned, in some examples, the breakdown voltage is created from capacitive discharge (e.g., from the control system 120, as shown in FIG. 4).

In some examples, an optimal spacing between the aperture 212 and the second contact 204 may be approximately 0.127 mm, or within a range of approximately 0.12 and approximately 0.13 mm, inclusive. Generally, design for such a spacing between the aperture 212 and the second contact 204 can account for breakdown voltage and flashover voltage of the dielectric layer 206.

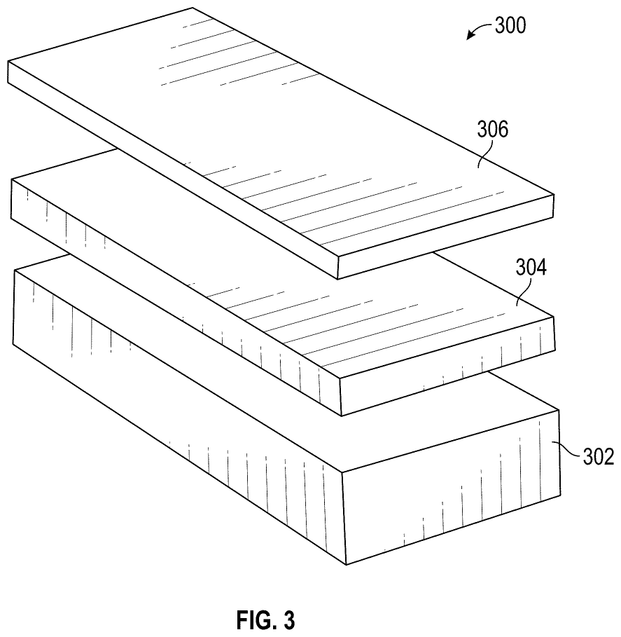

FIG. 3 illustrates an exploded view of layers of a PCB 300, as can be used for (e.g., within) various igniters disclosed herein, including the ignition strip 104, according to some examples. In the example shown, the PCB 300 includes a first conductive layer 302, a second conductive layer 304, and a dielectric layer 306. The first conductive layer 302 may include metallic materials, including aluminum or tin-coated steel. The second conductive layer 304 may include other metallic materials, including copper. In some examples, the material(s) used in manufacturing the first conductive layer 302 or the second conductive layer 304 may provide an increased flexibility of the PCB 300, including as further detailed below. Moreover, the dielectric layer 306 may include materials including glass or ceramics. In some examples, other materials, including polyimide flex, may be used in any of the layers of the PCB.

In some examples, one or more of the layers 302, 304, 306 of the PCB 300 may have optimized relative or absolute dimensions. For example, the dimensions may adhere to a repeatable minimum spacing for manufacturing of 0.076 mm (0.003 inches). Moreover, the thickness of one or more layers (e.g., of an aluminum layer) may be varied to achieve a PCB that can be bent.

In some examples, an exothermic welding apparatus can include a cup or other container with an internal area that contains a pre-measured amount of welding material. In some such examples, an igniter according to the present disclosure can be used in combination with a container, to provide a self-contained welding charge with included igniter. For example, the ignition strip 104 as discussed above and below can be secured at or in the internal area of a welding container, in various configurations, for ignition of welding material within the container (e.g., to thereby directly provide molten welding material to connect multiple conductors).

In some examples, the present disclosure may thus provide a self-contained, single-use welding capsules, including configured as shown for exothermic welding systems 400 or 420, shown in FIGS. 4A and 4B, respectively. Such a welding capsule can be used in an exothermic welding system (e.g., the exothermic welding system 100) to allow substantially streamlined and more reliable welding operations. Generally, for example, an internal area of a capsule can contain a main charge of exothermic welding material, transport and the operational ignition of the welding material. An igniter can extend into the internal area (e.g., across a sealed lip of a cup or other container), and corresponding electrical contacts can be arranged for engagement with a power source (e.g., ignition controller). Thus, for example, to easily ignite the welding material with the igniter, a user can simply place the capsule into a mold, connect the power source to the contacts, and then provide a sufficient current or voltage signal to activate the igniter.

With particular reference to the exothermic welding system 400 illustrated in FIG. 4A, in some examples, an internal volume 402 of a weld container 404 may be filled with a main charge 406 of welding material. In some examples, the container may be a cup made from stainless steel and include a refractory (e.g., graphite foil) liner, although other configurations are possible (e.g., with cups or other containers formed from other metallic materials or ceramics). A cover 408, configured as a foil membrane in some cases, may close off the internal volume 402. The exothermic welding system 400 further includes an igniter 410, which may in some examples include the PCB 300 of FIG. 3 or various other configurations as discussed above (e.g., may be an example configuration of the ignition strip 104).

In particular, the igniter 410 may include a PCB that forms an insulating gap 412 at an end that is in contact with the main charge 406 of welding material. Further, the igniter 410 in the illustrated example includes a bend along the PCB, within the internal volume, which orients the insulating gap 412 within the main charge 406 of welding material (e.g., with the PCB extending along spaced apart, parallel planes at opposite ends, in the example shown). Thus, upon application of breakdown voltage the PCB may provide a spark that causes the main charge 406 of welding material to ignite and thereby initiate the exothermic welding reaction. However, other configurations are possible in other examples (e.g., with other bend angles or contours).

Also as illustrated, the first end of the igniter 410 can protrude to the outside of the weld container 404 for application of an impulse voltage (or current), e.g., as provided by an ignition controller. Thus, it may be possible to easily attach a power source for ignition to the igniter 410, including after the container 404 has been placed into a welding mold (e.g., the mold 102 of FIG. 1). In other examples, however, other configurations are possible.

In some examples, a welding capsule or igniter can include an ignition charge of welding material, so that heat or molten material from ignition of the ignition charge can ignite a larger charge of welding material for welding operations. For example, as illustrated in FIG. 4B in particular, an ignition charge 422 of welding material is attached to an igniter 424 (e.g., otherwise identical to the igniter 410) and thereby held above a main charge 426 of welding material (or in other relation to the main charge 426, in other configurations). Such an ignition charge can be molded onto an igniter (e.g., as a solidified agglomeration at or within the insulating gap 412) or can be mechanically fixed (e.g., in a packet, pocket, cage, etc.). The PCB of the igniter 424 can accordingly provide a spark that ignites the ignition charge 422, and the resulting molten reaction products can fall to ignite the main charge 426 of welding material. In particular, the ignition charge 422 may not include starting material, which is known in the art to typically exhibit a significantly lower ignition temperature and to be subject to significantly more onerous regulations regarding handling and shipping than is (non-starting) welding material (e.g., to be classifiable as a division 4.1 flammable solid under 49 CFR § 173.124).

In different examples, bendable (or bent) PCB igniters, with or without attached ignition charges, can be used in other welding systems, including as part of or separately from welding capsules as discussed above. For example, an igniter similar to the igniters 410, 424 of FIGS. 4A and 4B may be inserted into a crucible of a weld mold to be embedded in or held above a main welding charge of loose or otherwise arranged welding material within the crucible (e.g., as generally shown in FIG. 1).

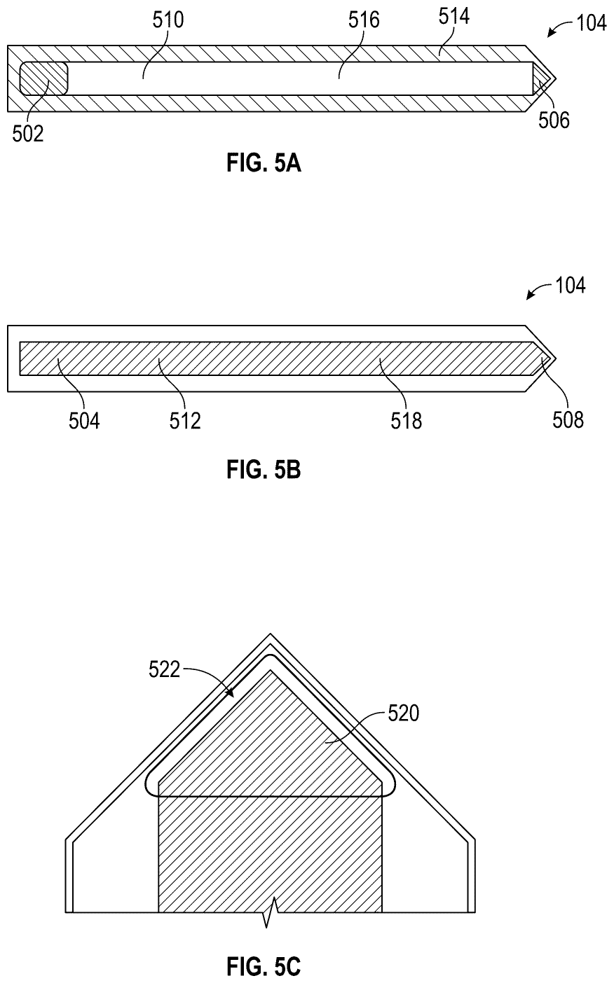

FIGS. 5A-5C schematically illustrate a second example board layout of the ignition strip 104 for exothermic welding processes. The example layout of the ignition strip 104 shown in FIGS. 5A-5C includes a PCB with a first contact 502, a second contact 504, a third contact 506, a fourth contact 508, a first conductive layer 510, a second conductive layer 512, and a dielectric layer 514. The dielectric layer 514 may be made from various appropriate dielectric materials (e.g., as discussed) above, and the first conductive layer 510 and the first contact 502 may be made of copper or other metallic material. The second conductive layer 512 and the second contact 504 may also be made of a metallic material.

As shown in FIG. 5A in particular, the first conductive layer 510 defines a first trace 516 between the first contact 502 and the third contact 506. The first contact 502 and the third contact 506 may include contact pads. In some examples, a contact pad on the first contact 502 can be configured to reduce the likelihood of breakdown occurring around the edges of the PCB at sharp corners. In some examples, the edges of the PCB may be rounded to accommodate higher voltages at the contacts 502, 506 during discharge. The first contact 502 may allow for connections to be made with an impulse cable, which can send voltage or current along the first trace 516 to initiate the exothermic welding process.

As illustrated in FIG. 5B, for example, the second conductive layer 512 defines a second trace 518 between the second contact 504 and the fourth contact 508. In some configurations, the fourth contact 508 may include a contact pad, such as contact pad 520 shown in FIG. 5C. The contact pad 520 of the fourth contact 508 may include sharp edges to encourage electrical breakdown to occur at the section of the board where the contact pad 520 is located (e.g., along the edges of the board, at the contact pad 520). In some examples, an air gap can be correspondingly provided between electrical traces (e.g., as shown at gap 522 in FIG. 5C), so that a sparkover electrical breakdown occurs upon application of a sufficiently large voltage difference.

Thus, examples of the disclosed technology can provide substantially improved ignition systems for exothermic welding, including improved igniter designs and improved methods of manufacturing for igniters. In some examples, PCB igniters can allow for more reliable ignition and can be manufactured in a variety of shapes, to thereby accommodate a wide range of welding applications.

The use herein of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Unless otherwise specified or limited, the terms “about” and “approximately,” as used herein with respect to a reference value, refer to variations from the reference value of ±20% or less (e.g., ±15, ±10%, ±5%, etc.), inclusive of the endpoints of the range.

The previous description of the disclosed examples is provided to enable any person skilled in the art to make or use the disclosed technology. Various modifications to these examples will be readily apparent to those skilled in the art, and the generic principles defined herein may be applied to other examples without departing from the spirit or scope of the disclosed technology. Thus, the disclosed technology is not intended to be limited to the examples shown herein but is to be accorded the widest scope consistent with the principles and novel features disclosed herein.

1. An ignition strip for exothermic welding, the ignition strip comprising:
a printed circuit board (PCB) that includes:
a first contact;
a second contact;
a dielectric layer with an aperture;
a first conductive layer defining a first trace between the first contact and the aperture along a first side of the dielectric layer; and
a second conductive layer defining a second trace between the second contact and the aperture along a second side of the dielectric layer;
the aperture defining an insulating gap between the first trace and the second trace to cause a spark for ignition of welding material upon application of a breakdown voltage across the first and second contacts.

2. The ignition strip of claim 1, wherein the PCB bends to extend along at least two reference planes.

3. The ignition strip of claim 2, wherein the first conductive layer is metallic.

4. The ignition strip of claim 3, wherein the first conductive layer includes aluminum.

5. The ignition strip of claim 4, wherein the second conductive layer includes copper.

6. The ignition strip of claim 1, wherein the breakdown voltage is approximately 120V or more.

7. The ignition strip of claim 1, wherein the PCB further includes an outer edge, wherein the PCB is configured to provide the spark as a result of a current traveling along the outer edge, between the first trace and the second trace.

8. An exothermic welding device comprising:
a weld container defining an internal volume that includes a main charge of welding material;
a cover that closes the internal volume to retain the main charge of welding material; and
an igniter that includes a printed circuit board (PCB) that defines an insulating gap between a first trace and a second trace to provide a spark for ignition of the main charge of welding material upon application of a breakdown voltage across the insulating gap, the PCB having a first end that protrudes outside of the weld container for application of the breakdown voltage.

9. The exothermic welding device of claim 8, wherein, at the insulating gap, the igniter is in contact with the main charge of welding material or an ignition charge of welding material.

10. The exothermic welding device of claim 9, wherein the igniter includes a bend within the internal volume to orient the insulating gap within the main charge of the welding material.

11. The exothermic welding device of claim 9, wherein the igniter is in contact with the ignition charge and the ignition charge does not include starting material.

12. The exothermic welding device of claim 8, further comprising a capacitor configured to apply a charge to the igniter to cause application of the breakdown voltage across the insulating gap.

13. The exothermic welding device of claim 8, wherein the insulating gap is arranged to cause discharge over an outer edge of the PCB upon application of the breakdown voltage.

14. A method of welding conductive components together, the method comprising:
providing an igniter that includes a printed circuit board (PCB) that defines a dielectric layer and an air gap between a first trace and a second trace;
aligning a weld container for a welding operation, with a first end of the igniter extending into the weld container and the weld container including a main charge of welding material;
applying a breakdown voltage across the air gap, via the first and second traces, to provide a spark that ignites a charge of welding material.

15. The method of claim 14, wherein the breakdown voltage is approximately 120V or more.

16. The method of claim 14, wherein the igniter extends within a sealed weld container that includes the charge of welding material.

17. The method of claim 14, wherein the igniter includes a first contact, a second contact, a first conductive layer in electrical communication with the first contact, and a second conductive layer in electrical communication with the second contact and separated from the first conductive layer by the air gap.

18. The method of claim 17, wherein at least one of the first conductive layer or the second conductive layer includes aluminum.

19. The method of claim 17, further comprising applying a capacitive discharge to the first contact to cause current to pass from the first trace to the second trace across the air gap via an outer edge of the PCB.

20. The method of claim 14, further comprising one or more of:
bending the igniter to extend along at least two reference planes; or
applying the breakdown voltage across the first and second contacts with the PCB extending along a different reference plane at the first and second contacts than at the air gap.
